(19) United States
(12) Patent Application Publication
(10) Pub. No.: US 2008/0165640 A1
(43) Pub. Date: Jul. 10, 2008

(54) OPTICAL DISC APPARATUS AND METHOD OF PERFORMING FINALIZE OPERATION THEREOF

(75) Inventor: Byung Hyuk CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Litd., Suwon-si (KR)

(21) Appl. No.: 11/862,357

(22) Filed: Sep. 27, 2007

(30) Foreign Application Priority Data
Jan. 8, 2007 (KR) 2007-1836

(51) Int. Cl. G11B 15/52; G11B 20/10

(52) U.S. Cl. 369/47.15

(57) ABSTRACT

An optical disc apparatus and a method of performing a finalize operation thereof are capable of automatically performing the finalize operation without separate manipulation by setting an easy (EZ) recording mode in the optical disc apparatus such as a digital video disc (DVD) recorder. The method includes determining whether or not a key for opening a disc is input by instruction of a user, comparing a capacity of data that is recorded on the disc with a remaining capacity of data that is not recorded on the disc when the key for opening the disc is input, and determining whether or not to automatically perform the finalize operation.

### CROSS-REFERENCE TO RELATED APPLICATIONS

This application claims the benefit of Korean Patent Application No. 2007-001836, filed on Jan. 8, 2007, in the Korean Intellectual Property Office, the disclosure of which is incorporated herein by reference in its entirety.

### BACKGROUND OF THE INVENTION

1. Field of the Invention

The present general inventive concept relates to an optical disc apparatus and a method of performing a finalize operation thereof, capable of automatically performing the finalize operation without separate manipulation by setting an easy (EZ) recording mode in the optical disc apparatus such as a digital video disc (DVD) recorder.

2. Description of the Related Art

With the development of video and audio media, a recording medium, for instance an optical disc such as a digital video disc (DVD), capable of recording and storing high-definition video data and high-quality audio data for a long time period has developed and commercialized. An optical disc apparatus such as a DVD recorder capable of recording/reproducing the video and audio data in/from the DVD has been developed and commercialized.

Recently, as a recordable capacity of the DVD has gradually increased, an optical disc apparatus on which a high-capacity built-in data recording medium such as a hard disc driver (HDD) is mounted as an HDD recorder, has been developed and expanded in use.

This optical disc apparatus is adapted to receive video and/or audio signals input through a television (TV) tuner or an external input line, and writes and records the received signals on the recording medium such as HDD, DVD, and video cassette recorder (VCR). When recorded, the optical disc apparatus is designed to select a corresponding broadcasting channel which a user sets on the basis of recording information, such as a broadcasting channel, a broadcasting date, and a recording time (start time and end time) for a broadcasting program to be recorded, through a setup screen (or a recording screen), and receives the broadcasting program to start or terminate the recording. However, when the recording is no longer performed on the recording medium, the optical disc apparatus is designed to stop the recording operation.

Meanwhile, after this optical disc apparatus records the disc, the user inserts the recorded disc into an appliance or player of another company. In this case, when recordable discs are not generally subject to finalize operation, they are not compatible with the appliance or player of another company. In this manner, when the user does not perform the finalize operation on the recordable disc, the disc is not compatible with appliances other than homogeneous appliances, it is not reproduced frequently. In this case, because common users do not understand the finalize operation of the disc, they recognize the disc as a defective product, and thus call for service. The finalize operation includes an operation of finalizing (or finishing up) a recording session of the disc and preventing adding additional tracks or data to the disc. When the disc is not finalized according to the finalize operation, the disc cannot be recognized or read in another optical disc apparatus.

In order to prevent this problem, the user must stand by while the recording operation is performed. Then, when the recording operation is complete, the user must perform the finalize operation on the disc by inputting a separate key for the finalize operation. This is very troublesome and ineffective from the viewpoint of time.

### SUMMARY OF THE INVENTION

The present general inventive concept provides an optical disc apparatus and a method of performing a finalize operation thereof, capable of automatically performing the finalize operation by setting an easy (EZ) recording mode in the optical disc apparatus such as a digital video disc (DVD) recorder although a user does not input a separate key after recording is complete.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of performing a finalize operation of an optical disc apparatus. The method includes determining whether or not a key for opening a disc is input by instruction of a user, and comparing a capacity of data that is to be recorded on the disc with a remaining capacity of data that is not recorded on the disc when the key for opening the disc is input, and determining whether or not to automatically perform the finalize operation.

The method may further include checking whether or not the data is recorded on the disc of the optical disc apparatus when the key for opening the disc is input. The determining of whether or not to automatically perform the finalize operation may include comparing the recorded capacity of the disc with the remaining capacity when the data is recorded on the disc, and determine a condition of the finalize operation.

The method may further include setting an easy (EZ) recording mode to automatically perform the finalize operation according to the user instruction. The determining of whether or not to automatically perform the finalize operation may include comparing the recorded capacity of the disc with the remaining capacity when the EZ recording mode is set, and determine a condition of the finalize operation.

The method may further include automatically perform the finalize operation on the disc when the recorded capacity is greater than the remaining capacity.

The method may further include determining whether or not recording is being performed when the key for opening the disc is not input, and checking whether or not the remaining capacity recordable on the disc is left when the recording is being performed, and the finalize operation is automatically performed on the disc when the remaining capacity recordable on the disc is not left.

The method may further include determining whether or not reservation recording is being performed when the remaining capacity recordable on the disc is left, and checking whether or not the reservation recording is complete, and the finalize operation is automatically performed on the disc when the reservation recording is complete.

The foregoing and/or other aspects and utilities of the present general inventive concept may be achieved by providing an optical disc apparatus, which includes an input unit that inputs a key for opening a disc according to a user instruction, and a microcomputer that compares a capacity of data that is recorded on the disc with a remaining capacity of data that is not recorded on the disc when the key for opening the disc is input, and determines whether or not to automatically perform a finalize operation.

The microcomputer may check whether or not the data is recorded on the disc when the key for opening the disc is input, compare the recorded capacity of the disc with the remaining capacity when the data is recorded on the disc, and automatically perform the finalize operation when the recorded capacity is greater than the remaining capacity.

The input unit may set an easy (EZ) recording mode to automatically perform the finalize operation by means of the user instruction.

The microcomputer may compare the recorded capacity of the disc with the remaining capacity when the EZ recording mode is set, and automatically perform the finalize operation when the recorded capacity is greater than the remaining capacity.

The microcomputer may determine whether or not recording is being performed when the key for opening the disc is not input, check whether or not the remaining capacity recordable on the disc is left when the recording is being performed, and automatically perform the finalize operation on the disc when the remaining capacity recordable on the disc is not left.

The microcomputer may determine whether or not reservation recording is being performed when the remaining capacity recordable on the disc is left, check whether or not the reservation recording is complete, and automatically perform the finalize operation on the disc when the reservation recording is complete.

The foregoing and/or other aspects and utilities of the present general inventive concept may be achieved by providing an optical disc apparatus including an input unit to select a mode to automatically perform a finalize operation on a disc, and a microcomputer to control the input unit to set the EZ mode before starting a recording operation to record data on the disc.

The optical disc apparatus may further include a display unit to display an image, the microcomputer may generate the image corresponding to a user interface including the mode to be displayed on the display unit, and the input unit may select the mode according to the displayed user interface.

The input unit may include a key designated to input the mode.

The input unit may include a plurality of keys, and the plurality of keys may include a key to exclusively input the mode.

The input unit may include a key to load a disc to start the recording operation to record data on the disc, and the microcomputer may automatically perform the finalize operation on the disc according to the mode set by the key.

The microcomputer may determine a capacity of the disc and perform the finalize operation according to the determined capacity and the set mode.

The microcomputer may determine a first capacity of a recoding space having recorded data of the disc and a second capacity of a remaining space of the disc and perform the finalize operation according to the determined first and second capacities.

The optical disc apparatus may further include a disc unit to record data on the disc, and the microcomputer may automatically perform the finalize operation according to the set mode after the disc unit performs the recording operation.

The microcomputer may perform the finalize operation when the recording operation is interrupted.

The foregoing and/or other aspects and utilities of the present general inventive concept may be achieved by providing an optical disc apparatus including a disc unit to record data on a disc, and a microcomputer to control the disc unit to automatically perform a finalize operation on the disc according to a mode set before a recording operation, after the recording operation is finished.

The foregoing and/or other aspects and utilities of the present general inventive concept may be achieved by providing an optical disc apparatus including a disc unit to record data on a disc, an input unit to select a mode to automatically perform a finalize operation on the disc, and a microcomputer to control the input unit to set the mode before starting a recording operation to record data on the disc, and the disc unit to perform the mode on the disc after the recording operation is finished.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a control block diagram illustrating an optical disc apparatus according to an embodiment of the present general inventive concept; and

FIGS. 2A and 2B are flowcharts illustrating a method of performing a finalize operation of an optical disc apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

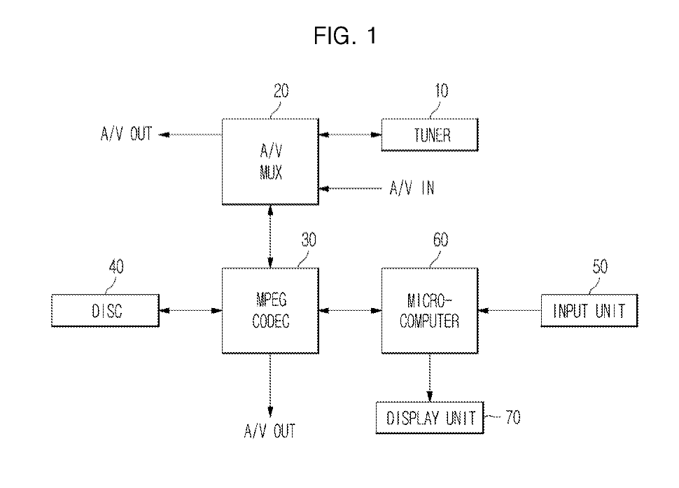

FIG. 1 is a control block diagram illustrating an optical disc apparatus according to an embodiment of the present general inventive concept. The optical disc apparatus includes a hard disc driver (HDD) in addition to an optical disc such as a digital video disc (DVD), so that it can write, record, read out, and reproduce video and audio data.

In FIG. 1, an optical disc apparatus of the present embodiment includes a tuner 10 to receive a broadcasting program of a channel set by a user, an audio/video multiplexer (A/V MUX) 20, a moving pictures experts group (MPEG) codec 30, a recording medium 40, an input unit 50, a microcomputer 60, and a display unit 70.

The tuner 10 functions to receive broadcasting signals from an external device or a broadcasting station (e.g., a broadcasting company) and then output the received broadcasting signals as video and audio signals. For example, the tuner 10 receives the broadcasting signals of broadcasting programs from each television (TV) broadcasting company through an antenna (ANT), tunes the received broadcasting signals to channels selected by the user, demodulates video and audio signals of the broadcasting programs, which are received through the tuned channels, to frequencies of desired channels, and outputs the demodulated video and audio signals as the video and audio signals.

The A/V MUX 20 switches signals which are input through the tuner 10 or input as an external input A/V IN through an external A/V apparatus, as the A/V OUT and outputs the video and audio signals A/V OUT to be displayed through the tuner 10 or the display unit 70 and/or to be transmitted the MPEG codec 30.

The MPEG codec 30 compresses the video and audio signals with a compression standard such as MPEG2 to generate an A/V data bit stream, or restores a compressed A/V data bit stream into the video and audio signals.

The recording medium 40 (hereinafter, referred to as “disc 40”) is any one selected from a hard disc driver, a digital video disc (DVD), a memory card, a disc loader, etc., each of which stores, deletes, edits, and reproduces contents such as broadcasting programs input from the tuner 10 or the external device or station. The DVD includes various formats (e.g., a video mode and a video recording (VR) mode).

The input unit 50 functions to input a user instruction related to a recording operation of the broadcasting programs using a specified button of a remote controller or a user interface (UI), and basically inputs a broadcasting channel, a broadcasting date, a recording time (start time and end time), and a quality of image for the broadcasting program to be recorded when the recording is set.

Further, the input unit 50 inputs a key such that an easy (EZ) recording mode to automatically perform a finalize operation of the disc 40 after the recording is compete is set for an on-and-off operation of turning on and off the power of the optical disc apparatus, and that the disc 40 is opened.

The finalize operation may be an operation of finalizing (or finishing up) a recording session of the disc and preventing adding additional tracks or data to the disc. When the disc is not finalized according to the finalize operation, the disc cannot be recognized or read in another optical disc apparatus,

The disc 40 may be a disc unit including a tray on which a disc is loaded, an optical unit to generate a beam to read data or write (record) data from or onto the disc, and a servo unit to control the disc and the optical unit to relatively move with respect to each other to read data or write (record) data (or A/V data of a MPEG codec) from or onto the disc using the beam.

The disc 40 is opened when a recording tray is pulled out from the optical disc apparatus to load the disc 40 on the recording tray to start the recording operation, or the recording tray with the disc 40 is pulled out from the optical disc apparatus to terminate the recording operation or for the user to pick out the disc 40 out of the recording tray.

The key for the EX recording mode is selected or pressed before the recording operation or session to record data on the disc 40. When a user interface is displayed on the display unit 70 to start the recording operation, a user may select a key in the displayed user interface to set the EZ recording mode to perform the finalize operation when recording is performed on the disc 40. When the EZ recording mode is selected, a user interface is not displayed on the display unit 70 for the user to select the finalize operation after the recording is performed.

The microcomputer 60 functions to control an overall operation of the optical disc apparatus according to the user instruction input through the input unit 50, and controls the disc 40 to automatically perform the finalize operation when the user opens the disc 40 based on the EZ recording mode set through the input unit 50.

Further, the microcomputer 60 checks whether or not data is recorded on the disc 40 when the key for opening the disc is input through the input unit 50 because the user may not want the finalize operation. In the case of recording the data on the disc 40, the microcomputer 60 checks an amount of recorded data (i.e., recorded capacity) and an amount of unrecorded data (i.e., remaining capacity), and automatically performs the finalize operation when the recorded capacity is greater than the remaining capacity.

Further, the microcomputer 60 checks whether or not the remaining capacity recordable on the disc 40 is left during the recording operation. If the remaining capacity is not left, the microcomputer 60 stops the recording to automatically perform the finalize operation. In contrast, if the remaining capacity is left, the microcomputer 60 checks whether or not reservation recording is being performed. If the reservation recording is being performed, the microcomputer 60 checks again whether or not the reservation recording is complete. When the reservation recording is complete, the microcomputer 60 automatically performs the finalize operation.

The display unit 70 functions to display the user instruction input through the input unit 50, and displays a menu related to the EZ recording mode on a setup screen so as to be able to automatically perform the finalize operation on the disc 40 when the key for setting the EZ recording mode is input.

Hereinafter, a method of performing a finalize operation of an optical disc apparatus will be described hereinafter.

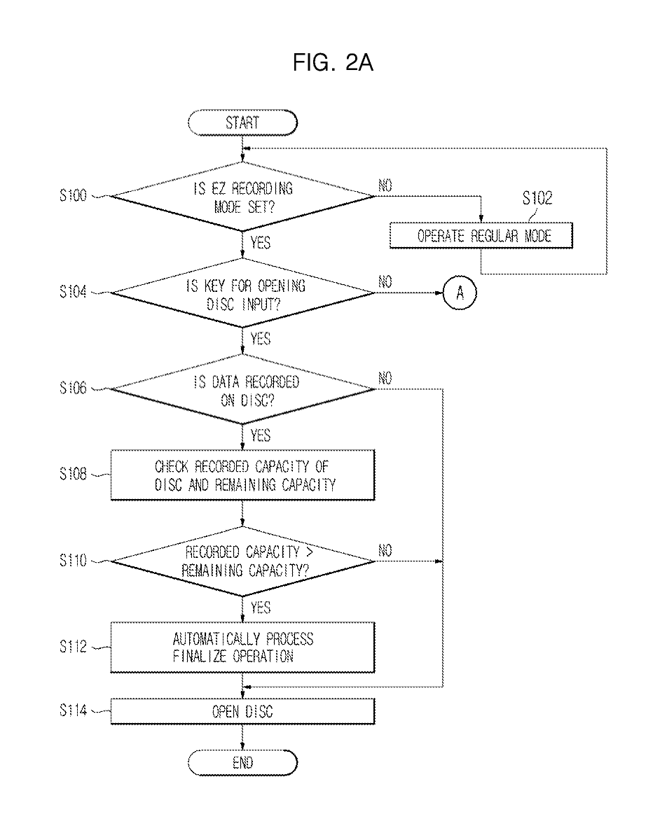

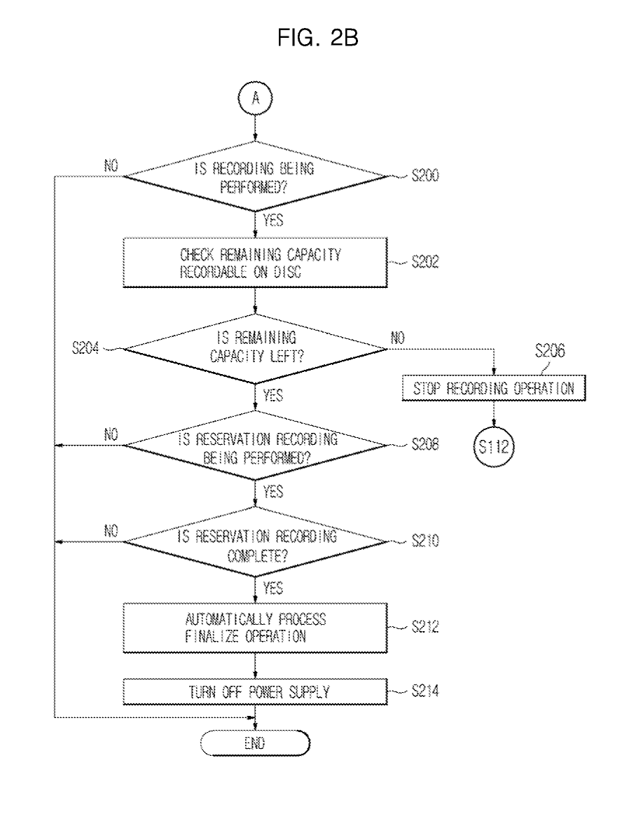

FIGS. 2A and 2B are flowcharts illustrating a method of performing a finalize operation of an optical disc apparatus according to an embodiment of the present general inventive concept.

Referring to FIGS. 1, 2A,and 2B, when a user inputs a key for setting an EZ recording mode through the input unit 50, a key signal corresponding to the setup of the EZ recording mode is input to the microcomputer 60 through the input unit 50.

Thus, the microcomputer 60 determines whether or not the EZ recording mode is set (S100). If the EZ recording mode is not set, the microcomputer 60 operates the optical disc apparatus in an existing regular mode (S102).

As a result of the determination, if the EZ recording mode is set, the microcomputer 60 determines whether or not the key for opening the disc is input through the input unit 50 (S104). If the key for opening the disc is input, the microcomputer 60 determines whether or not data is recorded on the disc 40 (S106). This is for performing the finalize operation only if the finalize operation is indispensable because the user may not want the finalize operation.

As a result of the determination in step S106, if the data is not recorded on the disc 40, the microcomputer 60 opens the disc 40, and terminates a program for the finalize operation (S114).

Meanwhile, as a result of the determination in step S106, if the data is recorded on the disc 40, the microcomputer 60 checks an amount of recorded data (i.e. recorded capacity) and an amount of unrecorded data (i.e. remaining capacity) (S108), and compares the checked recorded and remaining capacities of the disc 40 (S110).

As a result of the comparison, when the recorded capacity is less than the remaining capacity, the microcomputer 60 opens the disc 40, and comes to an end (S114).

In contrast, when the recorded capacity is greater than the remaining capacity, the microcomputer 60 automatically performs the finalize operation on the disc 40 (S112), opens the disc 40, and comes to an end (S114).

Further, as a result of the determination in step S104, if the key for opening the disc is not input through the input unit 50, the microcomputer 60 determines whether or not the recording is being performed on the disc 40 (S200). If the recording is not being performed, the microcomputer 60 comes to an end.

As a result of the determination in step 200, if the recording is being performed on the disc 40, the microcomputer 60 checks whether or not the remaining capacity recordable on the disc 40 is left (S202). If the remaining capacity recordable on the disc 40 is not left, the microcomputer 60 stops the recording operation (S206). Afterwards, the microcomputer 60 proceeds to step S112, automatically performs the finalize operation on the disc 40, opens the disc, and comes to an end.

Meanwhile, if the remaining capacity recordable on the disc 40 is left, the microcomputer 60 determines whether or not the reservation recording is being performed on the disc 40 (S208). If the reservation recording is not being performed, the microcomputer 60 comes to an end.

As a result of the determination in step S208, if the reservation recording is being performed, the microcomputer 60 checks whether or not the reservation recording is complete (S210). If the reservation recording is not complete, the microcomputer 60 comes to an end.

However, if the reservation recording is complete, the microcomputer 60 automatically performs the finalize operation on the disc 40 (S212), turns off a power supply, and comes to an end (S214).

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the optical disc apparatus and the method of performing the finalize operation thereof, the finalize operation can be automatically performed without separate manipulation only by setting the EZ function mode by the user even if the user is not skillful in using the optical disc apparatus such as the DVD recorder, so that it is not necessary for the user to wait until the recording operation is complete in order to perform the finalize operation, and the waste of time can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of performing a finalize operation of an optical disc apparatus, the method comprising:
determining whether or not a key for opening a disc is input by instruction of a user; and
comparing a capacity of data that is recorded on the disc with a remaining capacity of data that is not recorded on the disc when the key for opening the disc is input, and determining whether or not to automatically perform the finalize operation.

2. The method as claimed in claim 1, further comprising:
checking whether or not the data is recorded on the disc of the optical disc apparatus when the key for opening the disc is input,
Wherein the determining of whether or not to automatically perform the finalize operation comprises comparing the recorded capacity of the disc with the remaining capacity when the data is recorded on the disc, and determining a condition of the finalize operation.

3. The method as claimed in claim 1, further comprising:
setting an easy (EZ) recording mode to automatically perform the finalize operation according to a user instruction,
wherein the determining of whether or not to automatically perform the finalize operation comparing the recorded capacity of the disc with the remaining capacity when the EZ recording mode is set, and determining a condition of the finalize operation.

4. The method as claimed in claim 2, further comprising:
automatically performing the finalize operation on the disc when the recorded capacity is greater than the remaining capacity.

5. The method as claimed in claim 3, further comprising:
automatically performing the finalize operation on the disc when the recorded capacity is greater than the remaining capacity.

6. The method as claimed in claim 1, further comprising:
determining whether or not recording is being performed when the key for opening the disc is not input, and checking whether or not the remaining capacity recordable on the disc is left when the recording is being performed; and
automatically performing the finalize operation on the disc when the remaining capacity recordable on the disc is not left.

7. The method as claimed in claim 6, further comprising:
determining whether or not reservation recording is being performed when the remaining capacity recordable on the disc is left, and checking whether or not the reservation recording is complete; and
automatically performing the finalize operation on the disc when the reservation recording is complete.

8. An optical disc apparatus comprising:
an input unit that inputs a key for opening a disc according to a user instruction; and
a microcomputer that compares a capacity of data that is recorded on the disc with a remaining capacity of data that is not recorded on the disc when the key for opening the disc is input, and determines whether or not to automatically perform finalize operation.

9. The optical disc apparatus as claimed in claim 8, wherein the microcomputer checks whether or not the data is recorded on the disc when the key for opening the disc is input, compares the recorded capacity of the disc with the remaining capacity when the data is recorded on the disc, and automatically performs the finalize operation when the recorded capacity is greater than the remaining capacity.

10. The optical disc apparatus as claimed in claim 8, wherein the input unit sets an easy (EZ) recording mode to automatically perform the finalize operation according to the user instruction.

11. The optical disc apparatus as claimed in claim 10, wherein the microcomputer compares the recorded capacity of the disc with the remaining capacity when the EZ recording mode is set, and automatically performs the finalize operation when the recorded capacity is greater than the remaining capacity.

12. The optical disc apparatus as claimed in claim 8, wherein the microcomputer determines whether or not recording is being performed when the key for opening the disc is not input, checks whether or not the remaining capacity recordable on the disc is left when the recording is being performed, and automatically performs the finalize operation on the disc when the remaining capacity recordable on the disc is not left.

13. The optical disc apparatus as claimed in claim 12, wherein the microcomputer determines whether or not reservation recording is being performed when the remaining capacity recordable on the disc is left, checks whether or not the reservation recording is complete, and automatically performs the finalize operation on the disc when the reservation recording is complete.

14. An optical disc apparatus comprising:
an input unit to select a mode to automatically perform a finalize operation on a disc; and
a microcomputer to control the input unit to set the EZ mode before starting a recording operation to record data on the disc.

15. The optical disc apparatus of claim 14, further comprising:
a display unit to display an image,
wherein the microcomputer generates the image corresponding to a user interface including the mode to be displayed on the display unit, and the input unit selects the mode according to the displayed user interface.

16. The optical disc apparatus of claim 14, wherein the input unit comprises a key designated to input the mode.

17. The optical disc apparatus of claim 14, wherein the input unit comprises a key to load a disc to start the recording operation to record data on the disc, and the microcomputer automatically performs the finalize operation on the disc according to the mode set by the key.

18. The optical disc apparatus of claim 14, wherein the microcomputer determines a capacity of the disc and performs the finalize operation according to the determined capacity and the set mode.

19. The optical disc apparatus of claim 14, wherein the microcomputer determines a first capacity of a recoding space having recorded data of the disc and a second capacity of a remaining space of the disc and performs the finalize operation according to the determined first and second capacities.

20. The optical disc apparatus of claim 14, further comprising:
a disc unit to record data on the disc,
wherein the microcomputer automatically performs the finalize operation according to the set mode after the disc unit performs the recording operation.

21. The optical disc apparatus of claim 14, wherein the microcomputer automatically performs the finalize operation when the recording operation is interrupted

22. An optical disc apparatus comprising:
a disc unit to record data on a disc;
a microcomputer to control the disc unit to automatically perform a finalize operation on the disc according to a mode set before a recording operation, after the recording operation is finished.

23. An optical disc apparatus comprising:
a disc unit to record data on a disc;
an input unit to select a mode to automatically perform a finalize operation on the disc; and
a microcomputer to control the input unit to set the mode before starting a recording operation to record data on the disc, and the disc unit to perform the mode on the disc after the recording operation is finished.
